(19) United States
(12) Patent Application Publication
(10) Pub. No.: US 2014/0033242 A1
(43) Pub. Date: Jan. 30, 2014

(54) VIDEO SERVICE ASSURANCE SYSTEMS AND METHODS IN WIRELESS NETWORKS

(71) Applicants: Srinivasa RAO, Andover, MA (US); Atul BHATNAGAR, Saratoga, CA (US)

(72) Inventors: Srinivasa RAO, Andover, MA (US); Atul BHATNAGAR, Saratoga, CA (US)

(21) Appl. No.: 13/949,270

(22) Filed: Jul. 24, 2013

Related U.S. Application Data
(60) Provisional application No. 61/675,042, filed on Jul. 24, 2012.

(51) Int. Cl. H04N 21/442

(52) U.S. Cl. CPC H04N 21/442
USPC 725/14

(57) ABSTRACT

A computer-implemented method, a video service assurance system, and a wireless network with video service assurance provide analytics associated with video services in a network, such as Long Term Evolution (LTE) wireless networks, and actionable recommendations to improve the video services. In particular, the computer-implemented method of video service assurance includes obtaining measurement data and statistics from at least one network element in a network related to a plurality of video streams thereon, performing data aggregation and analysis with the measurement data and statistics related to the video streams, and providing actionable recommendations for improvement of the video streams to the at least one network element based on the data aggregation and analysis.

### CROSS-REFERENCE TO RELATED APPLICATION(S)

The present non-provisional patent application claims priority to U.S. Provisional Patent Application Ser. No. 61/675,042, filed Jul. 24, 2012, and entitled “VIDEO SERVICE ASSURANCE SYSTEMS AND METHODS IN WIRELESS NETWORKS,” which is incorporated in full by reference herein.

### FIELD OF THE INVENTION

Generally, the field of art of the present disclosure pertains to video over wireless networks, and more particularly, to video service assurance systems and methods that provide analytics associated with video services in wireless networks, such as Long Term Evolution (LTE) networks, and actionable recommendations to improve the video services.

### BACKGROUND OF THE INVENTION

Conventionally, wireless networks are ubiquitous and ever increasing in bandwidth, applications, etc. Currently, most wireless networks are deployed with 3G-based technologies, and service providers are in process of upgrading to 4G which includes LTE-based networks (see, e.g., D. Astely et al., “LTE: The Evolution of Mobile Broadband”, IEEE Communications Magazine, 44-51, April 2009). With the increase in bandwidth from 3G to 4G, handset providers are offering ever increasing hardware platforms with rich software applications. It is expected that video over wireless networks such as LTE networks will proliferate. While video may not be the primary application, video will dominate the bandwidth of wireless networks due to the characteristics of video traffic. For example, according to Cisco's Visual Networking Index (VNI), mobile video traffic accounts for more than 50% of mobile traffic today and is expected to grow to more than 70% of mobile traffic in 2016 (Cisco Visual Networking Index: Global Mobile Data Traffic Forecast Update, 2011-2016, February 2012). Thus, from a service provider's perspective, video traffic is expected to dominate wireless networks. That said, service providers are moving towards different product and pricing strategies for mobile data traffic (which includes video traffic). Thus, providing higher value services for high definition (HD) video over wireless networks provides opportunities to service providers for new, higher value service offerings. In this context, service providers will need to be able to ensure end users are “getting what they pay for.” Specifically, service providers will need to ensure good Quality of Experience (QoE) to end users. Disadvantageously for service providers, standard network Quality of Service (QoS) approaches (e.g., packet loss, delay, jitter, etc.) do not guarantee or necessarily correlate to good QoE.

### BRIEF SUMMARY OF THE INVENTION

In an exemplary embodiment, a computer-implemented method of video service assurance includes obtaining measurement data and statistics from at least one network element in a network related to a plurality of video streams thereon, performing data aggregation and analysis with the measurement data and statistics related to a subset of the video streams, and providing actionable recommendations for improvement of the video streams to the at least one network element based on the data aggregation and analysis. In another exemplary embodiment, a video service assurance system includes at least one server communicatively coupled to a network, wherein the network includes a plurality of user equipment (UE) participating in video streams over the network, and each of the at least one server comprises a network interface communicatively coupled to at least one network element in the network, a processor communicatively coupled to the network interface, and memory storing instructions that, when executed, cause the processor to: obtain measurement data and statistics from the network related to the video streams; perform data aggregation and analysis with the measurement data and statistics related to a subset of the video streams, and provide actionable recommendations for improvement of the video streams to the network based on the data aggregation and analysis.

In yet another exemplary embodiment, a wireless network with video service assurance includes a plurality of network elements forming a wireless network, wherein a plurality of user equipment is configured to participate in video streams over the wireless network, at least one server communicatively coupled to at least one of the plurality of network elements, and each of the at least one server comprises a network interface communicatively coupled to the at least one of the plurality of network elements, a processor communicatively coupled to the network interface, and memory storing instructions that, when executed, cause the processor to: obtain measurement data and statistics from the at least one of the plurality of network elements related to the video streams, perform data aggregation and analysis with the measurement data and statistics related to a subset of the video streams, and provide actionable recommendations for improvement of the video streams to the at least one of the plurality of network elements based on the data aggregation and analysis.

### BRIEF DESCRIPTION OF THE DRAWING(S)

Exemplary and non-limiting embodiments of the present disclosure are illustrated and described herein with reference to various drawings, in which like reference numbers denote like method steps and/or system components, respectively, and in which:

FIG. 1a is a network diagram of a video service assurance (VSA) system communicatively coupled to a wireless network focusing on elements in the wireless network;

FIG. 1b is a network diagram of a video service assurance (VSA) system communicatively coupled to a wireless network focusing on Multimedia Broadcast Multicast Service related elements in the wireless network;

FIG. 2 is a network diagram of a video service assurance (VSA) system communicatively coupled to a wireless network focusing on elements in the VSA system;

FIG. 3 is a block diagram of a server for use in the video service assurance (VSA) system and method; and

FIG. 4 is a block diagram of an exemplary User Equipment (UE) for use on the wireless network of FIGS. 1a, 1b, and 2.

### DETAILED DESCRIPTION OF THE INVENTION

In various exemplary embodiments, the present disclosure relates to video service assurance systems and methods that provide analytics associated with video services in wireless networks, such as Long Term Evolution (LTE) networks, and actionable recommendations to improve the video services. In particular, the video service assurance systems and methods can include a cloud-based or server-based big data analytics service. This big data analytics service can be used with wireless networks (e.g., LTE), but also can be used with other network types such as Wireless local area networks (WLAN), wireline networks (e.g., telco, cable, etc.), and the like. Variously, the big data analytics service can be a multi-tenant platform capable of supporting multiple service providers concurrently with a geographically redundant service that can be hosted in multiple data centers.

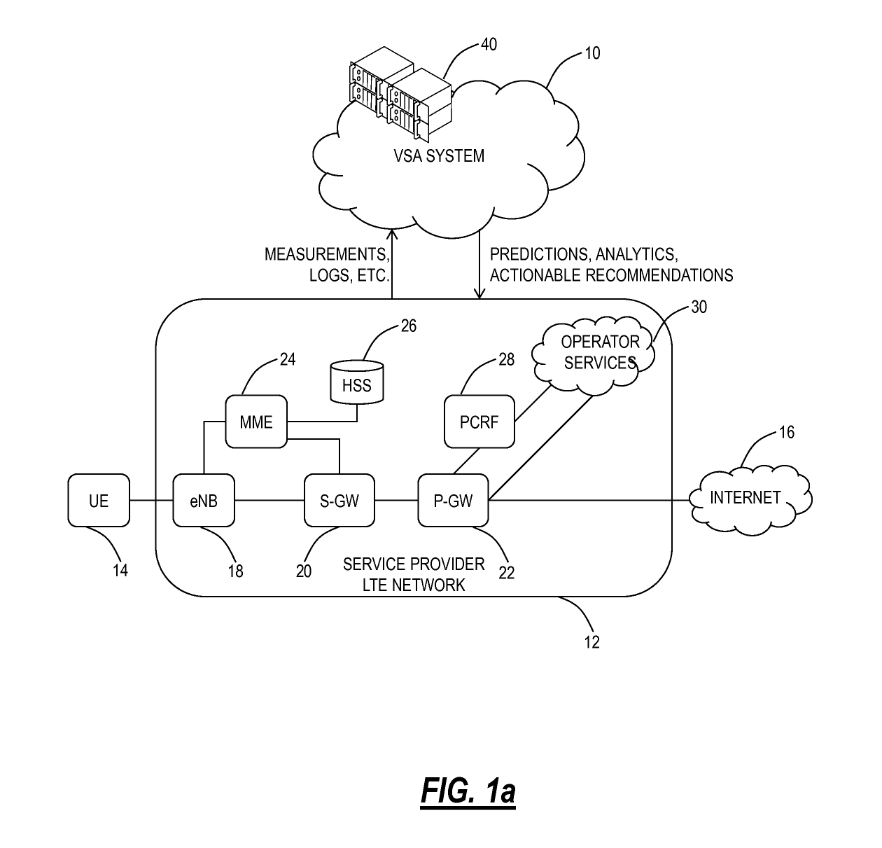

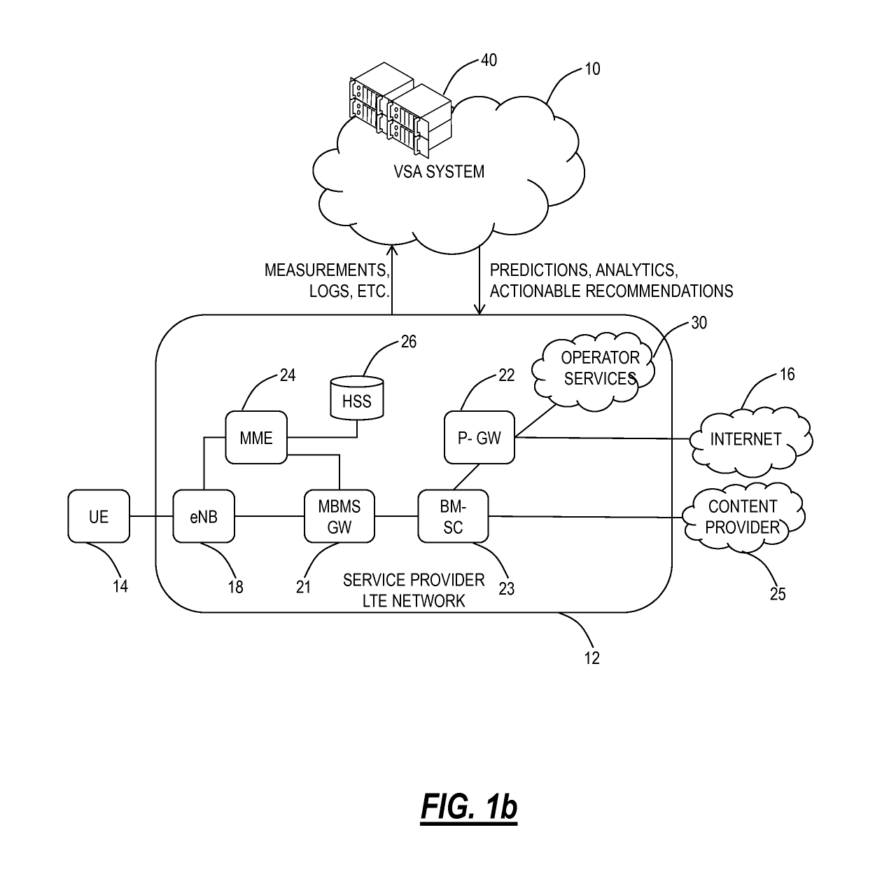

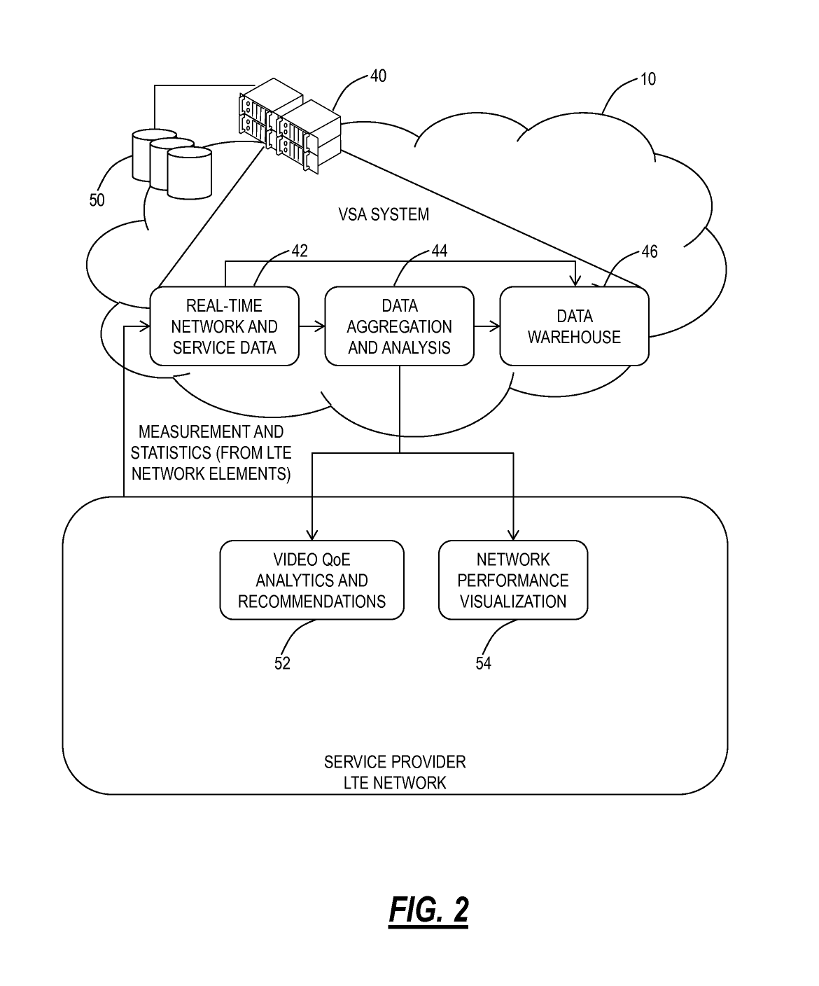

Referring to FIGS. 1a, 1b, and 2, in an exemplary embodiment, network diagrams illustrate a video service assurance (VSA) system 10 communicatively coupled to a wireless network 12 for monitoring and adjusting video services thereon. FIGS. 1a and 1b illustrate elements in the wireless network 12, and FIG. 2 illustrates elements in the VSA system 10. In FIGS. 1a and 1b, a mobile device 14 (User Equipment (UE)) is configured to connect with the wireless network 12. The mobile device 14 can include a smart phone, a tablet, a personal digital assistant, a laptop, an ultra book, a net book, or any other platform configured to access the wireless network 12. A single mobile device 14 is illustrated in FIGS. 1a and 1b, but those of ordinary skill in the art will recognize that the wireless network 12 will have a significant number of mobile devices 14 connected thereto. The mobile device 14 is configured to communicate with an external network 16 such as the Internet through the wireless network 12. In the foregoing descriptions and for illustration purposes, the wireless network 12 is an LTE radio access network (RAN).

For accessing the wireless network 12, the mobile device 14 wirelessly interfaces with an eNB 18 (i.e., a base station), e.g. an E-UTRAN (Evolved Universal Terrestrial Radio Access (E-UTRA)) Node B (eNB). For example, the eNB 18 is the air interface for LTE, and the air interface is referred to as an LTE-Uu. The eNB 18 interfaces with the System Architecture Evolution (SAE) core (also known as Evolved Packet Core (EPC)) and other eNBs. The core can include a Serving Gateway (S-GW) 20, a Packet Data Network (PDN) gateway 22, and a Mobility Management Entity (MME) 24. The eNB 18 uses the S1-AP (Application Protocol) protocol on an S1-MME interface with the MME 24 for control plane traffic, and the eNB 18 uses the General Packet Radio Service (GPRS) Tunneling Protocol (GTP) (collectively referred to as the GTP-U protocol) on an S1-U interface with the S-GW 20 for user plane traffic. Collectively the S1-MME and S1-U interfaces are known as the S1 interface, which represents the interface from eNB 18 to the core EPC. The eNB 18 uses the X2-AP protocol on the X2 interface with other eNB elements.

The MME 24 is the key control-node for an LTE RAN. The MME 24 is responsible for idle mode UE 14 tracking and paging procedure including retransmissions. The MME 24 is involved in the bearer activation/deactivation process and is also responsible for choosing the S-GW 20 for the UE 14 at the initial attach and at time of intra-LTE handover involving Core Network (CN) node relocation. The MME 24 is responsible for authenticating the user (by interacting with a Home Subscriber Server (HSS) 26). The Non Access Stratum (NAS) signaling terminates at the MME 24 and the MME 24 is also responsible for generation and allocation of temporary identities to UEs 14. Additionally, the MME 24 checks the authorization of the UE 14 to camp on a service provider's Public Land Mobile Network (PLMN), enforces UE 14 roaming restrictions, is the termination point in the network 12 for ciphering/integrity protection for NAS signaling, handles the security key management, provides the control plane function for mobility between LTE and 2G/3G access networks with the S3 interface terminating at the MME from a Serving GPRS Support Node (SGSN), terminates the S6a interface towards the home HSS 26 for roaming UEs 14, and the like. The HSS 26 is a central database that contains user-related and subscription-related information. The functions of the HSS 26 include functionalities such as mobility management, call and session establishment support, user authentication, access authorization, and the like

The S-GW 20 routes and forwards user data packets, while also acting as the mobility anchor for the user plane during inter-eNB 18 handovers and as the anchor for mobility between LTE and other 3rd Generation Partnership Project (3GPP) technologies (terminating S4 interface and relaying the traffic between 2G/3G systems and the P-GW 22). For idle state UEs 14, the S-GW 20 terminates the downlink data path and triggers paging when downlink data arrives for the UE 14. The S-GW 20 manages and stores UE 14 contexts, e.g. parameters of the IP bearer service, network internal routing information. The P-GW 22 provides connectivity from the UE 14 to external packet data networks by being the point of exit and entry of traffic for the UE 14. The UE 14 may have simultaneous connectivity with more than one P-GW 22 for accessing multiple PDNs. The P-GW 22 performs policy enforcement, packet filtering for each user, charging support, lawful interception and packet screening. Another key role of the P-GW 22 is to act as the anchor for mobility between 3GPP and non-3GPP technologies such as WiMAX and 3GPP2 (CDMA 1X and EvDO).

The P-GW 22 connects to a Policy and Charging Rules Function (PCRF) device 28, operator services 30, and the external network 16. The PCRF device 28 is responsible for policy control decision-making, as well as for controlling the flow-based charging functionalities in a Policy Control Enforcement Function (PCEF), which resides in the P-GW 22. The PCRF device 28 provides QoS authorization (QoS class identifier [QCI] and bit rates) that decides how a certain data flow will be treated in the PCEF and ensures that this is in accordance with the user's subscription profile. The operator services 30 can include a network operator's IP services such as IP Multimedia Subsystem (IMS), Packet Switched Streaming (PSS), etc. The external network 16 can be the Internet or any other network including content such as video for streaming through the wireless network 12 to the UE 14.

Another key service for distribution of video content over broadband wireless networks is the 3GPP Multimedia Broadcast and Multicast Service (MBMS). MBMS enables distribution of video and other content from a single source (content provider) to multiple recipients (UEs) simultaneously with efficient utilization of radio resources. As depicted in FIG. 1b, MBMS is realized by adding new functional entities to the 3GPP LTE architecture. MBMS GW (MBMS Gateway) 21 distributes user plane data to all eNBs transmitting the service and controls session initiation and termination. BM-SC (Broadcast Multicast Service Center) 23 is the entry point in 3GPP networks to MBMS services and provides functions for MBMS service announcement, user service initiation and delivery. Another entity MCE (Multi-cell/Multicast Coordination Entity) that controls allocation of radio resources in eNodeBs is not shown. As shown in FIG. 1b, VSA system can provide service assurance not only to unicast video services as described earlier, but also to broadcast/multicast services based on 3GPP MBMS architecture, without modification.

In context of the systems and methods described herein, the UE 14 and a plurality of additional UEs are streaming video services over the wireless network 12. The VSA system 10 is an overlaid or adjunct system to the wireless network 12 (and optionally to one or more additional wireless networks (not shown)) that performs analytics associated with video connections and provides actionable recommendations based thereon. The VSA system 10 includes one or more servers 40 communicatively coupled to the wireless network 12 for receiving real-time and/or log measurements and statistics from the LTE network elements in the wireless network 12 including application/service platforms and mobile devices. In implementation, the servers 40 can form a cloud-based big data analytics service that is a multi-tenant platform capable of monitoring the wireless network 12 as well as various additional wireless networks around the world.

FIG. 2 illustrates the servers 40 forming the VSA system 10 and various functional aspects associated therewith. Specifically, the servers 40 includes a real-time network and service data collection function 42, a data aggregation and analysis function 44, and a data warehouse function 46. These can be implemented in the servers 40 which can also be communicatively coupled to various data stores 50. The data collection function 42 is communicatively coupled to the wireless network 12 and configured to receive measurements, statistics and logs from network elements in the wireless network 12 including the various eNBs 18, gateways 20, 22, MMEs 24, HSSs 26, etc. as well as other devices which may participate in the wireless network 12 such as WLAN access points (APs), switches, etc. This data collection can include real-time data, substantially real-time data, historical log data, and combinations thereof In an exemplary embodiment, data collection primarily relies on non-intrusive acquisition of logs generated. In another exemplary embodiment, the data collection can utilize software agents included in the wireless network 12 on various network elements for providing the data to the data collection function 42. For example, the non-intrusive acquisition of logs can monitor historical data whereas the software agents can be used to provide real-time or substantially real-time data. Variously, the VSA system 10 through the functions 42, 44 seeks to mine or leverage existing data through logs from the wireless network 12 coupled with real-time or almost real-time data to detect problematic video streams and to provide feedback for improvement thereof

The VSA system 10 through the servers 40 and the functions 42, 44, 46 is configured to analyze network video data streams continuously to monitor and predict video quality issues in real-time or substantially in real-time. Specifically, the data collection function 42 obtains the data as described herein, and the data aggregation and analysis function 44 is configured to perform the analysis. That is, the analysis function 44 receives inputs from the collection function 42 and provides outputs to network elements in the wireless network 12 and to the data warehouse function 46. The data warehouse function 46 is utilized to store collected data from the data collection function 42 as well as computed analytics from the analysis function 44 for future analysis. The data warehouse function 46 can store the data in the data store 50.

The analysis function 44 is also configured to provide actionable recommendations to the wireless network 12 based on computed analytics. Specifically, the VSA system 10 provides analytics as well as real-time feedback to the wireless network 12 to improve video streams thereon. For example, the servers 40 can be communicatively coupled to any of the elements in the wireless network 12, i.e. the eNB 18, the gateways 20, 22, the MME 24, the HSS 26, the PCRF 28, etc. for providing feedback. The objective of the VSA system 10 through the analysis function 44 is to proactively detect video stream problems for immediate correction thereof before the situation elevates to a customer complaint. The VSA system 10 is predictive based on prior data from the wireless network 12 stored in the data warehouse function 46, proactive based on current or substantially current data from the wireless network 12, and corrective in providing specific feedback to the various network elements in the wireless network 12.

The analysis function 44 is configured to utilize various video quality prediction techniques based on machine learning algorithms and big data analytics. These algorithms include traditional batch mode learning methods such as decision trees, support vector machines, Bayesian networks, clustering, ensemble learning algorithms, and Markov Chain Monte Carlo (MCMC) algorithms as well as versions of these algorithms adapted to data stream processing. Exemplary algorithms are described in, e.g., C. Andrieu et al., “An Introduction to MCMC for Machine Learning”, Machine Learning, 50, 5-43, 2003; X. Wu et al., “Top 10 algorithms in data mining”, Knowledge and Information Systems, 14(1), 1-37, 2008; and S. Muthukrishnan, Data streams: Algorithms and applications, Foundations and Trends in Theoretical Computer Science Vol. 1, No 2 (2005) 117-236 (2005); the contents of each are incorporated by reference herein. The analysis function 44 explicitly incorporates domain knowledge from the wireless networks as well as from the unique characteristics of the video application. The analysis function 44 can operate in supervised, semi-supervised or unsupervised learning mode depending on the amount of labeled training data available. Based on the video quality predictions, the analysis function 44 provides actionable recommendations to the wireless network 12 for addressing QoE issues. Exemplary actionable recommendations can include increasing network buffer sizes, reducing the number of admitted sessions on the radio network, etc. These actionable recommendations can be configured to be automatically implemented by the wireless network 12 or provided as suggestions for operator approval prior to implementation. Specifically, the analysis function 44 can provide Video QoE analytics and recommendations 52 to various network elements in the network 12 or to operators of the network elements. Also, the analysis function 44 can provide network performance visualization data 54 to the operators such as through the interactive GUI.

In practical deployments, it is expected that the wireless network 12 will experience thousands or even millions of video streams concurrently. In this context, the VSA system 10 can include a hierarchical approach enabling real-time analysis by monitoring the video streams. This can include the analysis function 44 predicting (referred to as regression) video QoE parameters using the algorithms described above in [0023]. Various types of QoE parameters (described further in [0025] and [0026]) can be selected based on the network service provider's preference. Performing regression on the video QoE parameters initially (rather than simpler direct classification into good or poor video QoE classes) not only provides a quantitative measure of QoE, it also allows the service provider to configure context based thresholds that are then used to classify the video sessions into good or poor QoE sessions. For example, the thresholds can be predetermined through experimentation and indicative of what good or poor QoE sessions look like. Example contexts for setting thresholds include time-of-day (allowing higher tolerance for video degradation outside of business hours), or user subscription level (stringent quality settings for Business Premium package subscribers). These steps enable the VSA system 10 to first identify a small set of video sessions that were likely adversely impacted by network performance issues. The VSA system 10 can perform a drill down for a detailed analysis of the identified subsets of the video streams, either individually or at a specified aggregate level such as sessions within a cell site. For example, the analysis function 44 may identify deviations of network element configuration parameter values, or other measurements, from their nominal ranges corresponding to good quality sessions and derive recommendations to the operator, on the configuration updates required to improve the video session quality. Additionally, the VSA system 10 can include an intuitive Graphical User Interface (GUI) for service providers to access video quality analysis, predictions and recommendations with drill-down capability.

As described herein, an objective of the VSA system 10 is for service providers, such as LTE network providers, to ensure good video Quality of Experience (QoE) to end users. Further, as described herein, standard network QoS approaches (such as controlling packet delay, jitter etc.) do not guarantee good QoE. Video quality is typically better quantified by subjective measures (such as Mean Opinion Score (MOS)), but can also be quantified by objective metrics (that can be different from objective metrics in QoS approaches). Of course subjective metrics are not suitable for automated deployments. Thus, the VSA system 10 contemplates objective metrics optimized for QoE in video streams. The objective metrics can be computed in real or near real-time. The VSA system 10 seeks to use objective metrics that are accurate predictors or are correlated with subjective metrics. Objective metrics can be Full-Reference (FR) metrics, when original video is available to compare with received video; Partial-Reference (PR) metrics, when only a subset of aspects or original video are available; and No-Reference (NR) metrics, when original video is not available. For example, several objective metrics that are accurate predictors of MOS include peak signal-to-noise ratio (PSNR) which is a FR metric, Structural SIMilarity (SSIM) index which is a FR metric, blocking and blurring metrics which are NR metrics, and the like.

The analysis function 44 can support two levels/approaches of Video Quality Metric (VQM) computation. A first level, VQM1, can include computing Video Quality (VQ) metrics based on received video in real-time. In an exemplary embodiment, the first level, VQM1, can include two computation options, VQM1a and VQM1b. For the first option, VQM1a, the analysis function 44 can utilize parameters/measurements from the original video, transmitted to the UE 14 along with the original video, leading to PR metrics. For the second option, VQM1b, the analysis function 44 can compute NR metrics based on received video alone by the UE 14. A second level, VQM2, can include recording and storing the most recent N video sessions (i.e. sequence of received video frames for each session) at the UE 14, N being a positive integer. If video quality issues arise, the stored video session is retrieved by the analysis function 44 along with the original transmitted video to derive comprehensive FR metrics.

These video quality metric computation approaches enhance the current state of the art for example as standardized in 3GPP MBMS QoE metrics feature (3GPP Technical Specification 26.346, v11.5.0, MBMS: Protocols and codecs, June 2013). The QoE metrics required to be implemented by MBMS client (such as corruption duration, rebuffering duration, successive loss of Real Time Protocol (RTP) packets, frame rate deviation, jitter duration etc.) are a subset of various metrics that can be computed by the VSA system 10. Furthermore, the VSA system 10 can generalize the approaches used by the 3GPP MBMS system to activate the collection of QoE metrics using the IETF standard Session Description Protocol (SDP) on a session basis, or using Open Mobile Alliance (OMA) Device Management (OMA DM) standard for pre-provisioning. This generalization covers broadcast multicast video sessions as well as unicast video sessions. Additional metrics not standardized can be supported using the vendor specific extensions for e.g. in OMA DM Managed Object. Reuse of standard approaches in implementing QoE provisioning enables faster development and deployment of the VSA system 10 and the necessary support in wireless networks and devices.

Quality of received video in networks, such as LTE networks, depends on a very large set of variables and parameters. A few examples of the variables and parameters include video source related (codec, resolution, etc,), transcoding/transrating, network buffer sizes, radio interface available capacity, subscriber device capabilities (screen size, resolution), subscription level, etc. Accordingly, the VSA system 10 utilizes machine learning and big data analytic approaches best suited for prediction of video performance, given the network measurements. These approaches include traditional batch mode learning methods such as decision trees, support vector machines, Bayesian networks, clustering, ensemble learning algorithms, and Markov Chain Monte Carlo (MCMC) algorithms as well as versions of these algorithms adapted to data stream processing.

The VSA system 10 aggregates sets of data collected from numerous entities in the network 12 in real-time, near-real-time, or historical logs. Such a collection meets the criteria such as volume, velocity, and variety that typically characterize big data. Note, the VSA system 10 can also store the actual video stream data as well for future analysis, etc. The VSA system 10 can include both structured as well as unstructured data. In this context, network and video service performance data such as the measurements and statistics collected from the network elements and the UE fall into the structured data category, while the logs collected from the network elements and the video stream content are unstructured data. The VSA system 10 can leverage cloud networking architectures, off-the-shelf server hardware and data storage, open source software such as Hadoop, etc. to make big data processing scalable and cost effective. The VSA system 10 is suitable for a higher scale of data, and stringent real-time requirements than the statistical methods based on random sampling. Further, the VSA system 10 is adaptable and capable of supporting various different type of algorithms (e.g., streaming algorithms), and different type of metrics (such as frequency moments, Lp distances instead of mean, median etc.) best suited for big data.

Thus, the VSA system 10 and methods associated therewith provide Video (including High Definition (HD)) quality prediction from analysis of network data streams. The data collection function 42 is based primarily on non-intrusive analysis of generated logs from network elements, but can include software agents on the network elements and the like. Advantageously, the VSA system 10 is configured for distillation of the network data and the video quality predictions to provide actionable recommendations to service provider to address video performance issues. While described with respect to wireless networks such as LTE, the VSA system 10 can support video assurance over any type of network and physical media.

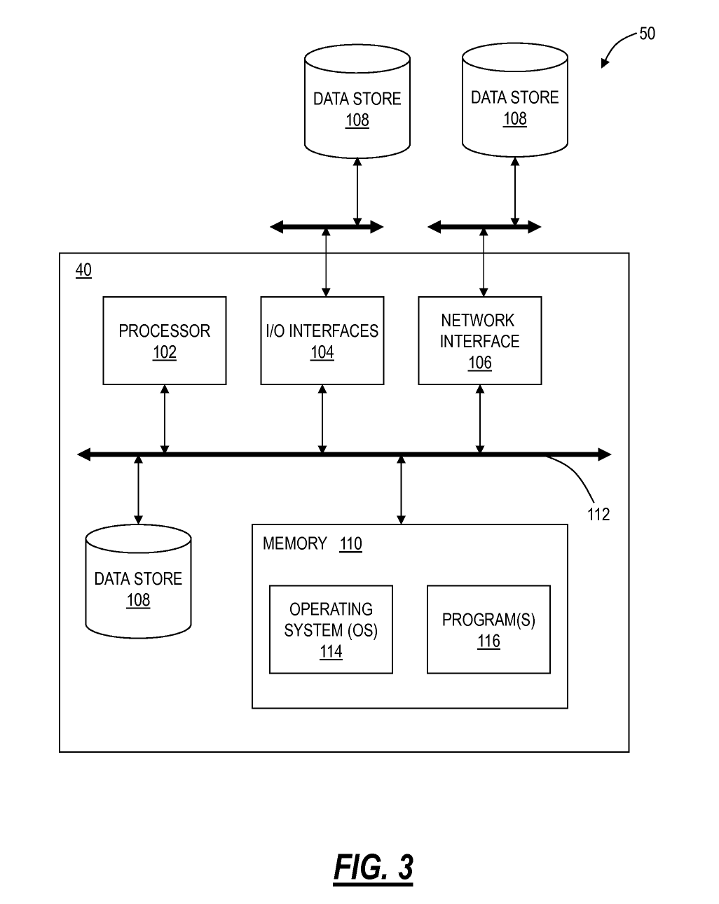

Referring to FIG. 3, in an exemplary embodiment, a block diagram illustrates a server 40 for use in the VSA system 10 and the various methods described herein. The server 40 can be a digital computer that, in terms of hardware architecture, generally includes a processor 102, input/output (I/O) interfaces 104, a network interface 106, a data store 108, and memory 110. It should be appreciated by those of ordinary skill in the art that FIG. 3 depicts the server 40 in an oversimplified manner, and a practical embodiment may include additional components and suitably configured processing logic to support known or conventional operating features that are not described in detail herein. The components (302, 104, 106, 108, and 110) are communicatively coupled via a local interface 112. The local interface 112 can be, for example but not limited to, one or more buses or other wired or wireless connections, as is known in the art. The local interface 112 can have additional elements, which are omitted for simplicity, such as controllers, buffers (caches), drivers, repeaters, and receivers, among many others, to enable communications. Further, the local interface 112 can include address, control, and/or data connections to enable appropriate communications among the aforementioned components.

The processor 102 is a hardware device for executing software instructions. The processor 102 can be any custom made or commercially available processor, a central processing unit (CPU), an auxiliary processor among several processors associated with the server 40, a semiconductor-based microprocessor (in the form of a microchip or chip set), or generally any device for executing software instructions. When the server 40 is in operation, the processor 102 is configured to execute software stored within the memory 110, to communicate data to and from the memory 110, and to generally control operations of the server 40 pursuant to the software instructions. The I/O interfaces 104 can be used to receive user input from and/or for providing system output to one or more devices or components. User input can be provided via, for example, a keyboard, touch pad, and/or a mouse. System output can be provided via a display device and a printer (not shown). I/O interfaces 104 can include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 106 can be used to enable the server 40 to communicate on a network. The network interface 106 can include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 106 can include address, control, and/or data connections to enable appropriate communications on the network. A data store 108 can be used to store data. The data store 108 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 can incorporate electronic, magnetic, optical, and/or other types of storage media. In one example, the data store 108 can be located internal to the server 40 such as, for example, an internal hard drive connected to the local interface 112 in the server 40. Additionally in another embodiment, the data store 108 can be located external to the server 40 such as, for example, an external hard drive connected to the I/O interfaces 104 (e.g., SCSI or USB connection). In a further embodiment, the data store 108 can be connected to the server 40 through a network, such as, for example, a network attached file server. For example, the externally connected data stores 108 can form the data store 50.

The memory 110 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 110 can incorporate electronic, magnetic, optical, and/or other types of storage media. Note that the memory 110 can have a distributed architecture, where various components are situated remotely from one another, but can be accessed by the processor 102. The software in memory 110 can include one or more software programs, each of which includes an ordered listing of executable instructions for implementing logical functions. The software in the memory 110 includes a suitable operating system (O/S) 114 and one or more programs 116. The operating system 114 essentially controls the execution of other computer programs, such as the one or more programs 116, and provides scheduling, input-output control, file and data management, memory management, and communication control and related services. The one or more programs 116 may be configured to implement the various processes, algorithms, methods, techniques, etc. described herein. For example, the programs 116 can be configured to enable the methods described herein.

The VSA system 10 can be formed through a single server 40, a cluster of servers 40, a plurality of geographically dispersed servers 40, and the like. In all of the foregoing, the data store 50 can be shared across the multiple servers 40. The data collection function 42 can be implemented through the network interface 106 which can be communicatively coupled to at least one network element in the wireless network 12 (or a plurality of network elements). The data collection function 42 can provide the measurements, statistics and logs to the data stores 50, 108. The analysis function 44 can utilize the measurements and statistics from the data collection function 42 and perform analytics using the processor 102. Outputs of the analysis function 44 can be sent to the at least one network element in the wireless network 12 via the network interface 106. These outputs can include the Video QoE analytics and recommendations 52 and the network performance visualization data 54.

Thus, for the VSA system 10, the servers 40, and the functions 42, 44, 46, it will be appreciated that some exemplary embodiments described herein may utilize the processor 102 which can include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

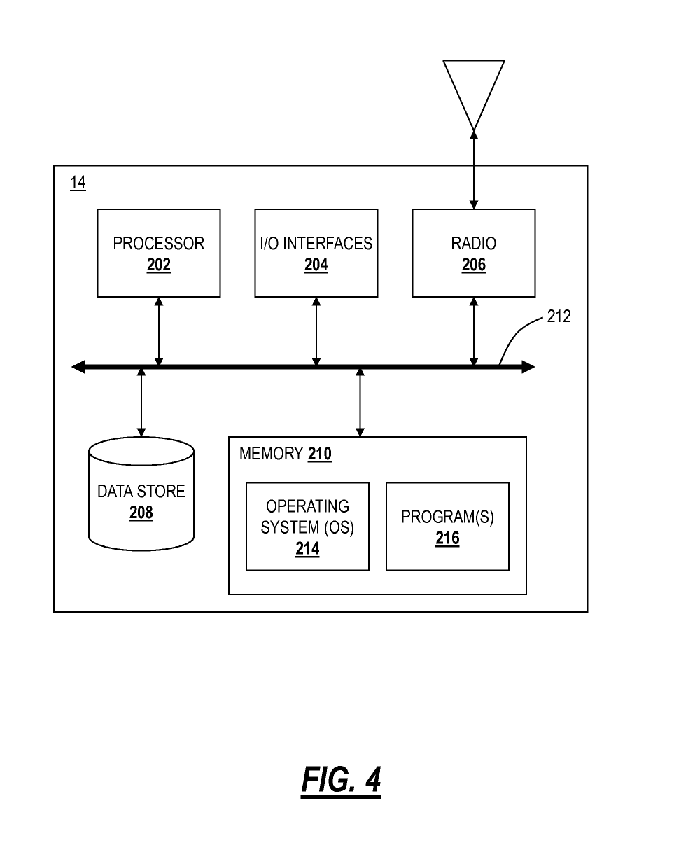

Referring to FIG. 4, in an exemplary embodiment, a block diagram illustrates an exemplary implementation of a UE 14 in the wireless network 12 and the various methods described herein. The UE 14 can be a digital device that, in terms of hardware architecture, generally includes a processor 202, input/output (I/O) interfaces 204, a radio 206, a data store 208, and memory 210. It should be appreciated by those of ordinary skill in the art that FIG. 4 depicts the UE 14 in an oversimplified manner, and a practical embodiment can include additional components and suitably configured processing logic to support known or conventional operating features that are not described in detail herein. The components (202, 204, 206, 208, and 210) are communicatively coupled via a local interface 212. The local interface 212 can be, for example but not limited to, one or more buses or other wired or wireless connections, as is known in the art. The local interface 212 can have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 can be any custom made or commercially available processor, a central processing unit (CPU), an auxiliary processor among several processors associated with the UE 14, a semiconductor-based microprocessor (in the form of a microchip or chip set), or generally any device for executing software instructions. When the UE 14 is in operation, the processor 202 is configured to execute software stored within the memory 210, to communicate data to and from the memory 210, and to generally control operations of the UE 14 pursuant to the software instructions. In an exemplary embodiment, the processor 202 may include a mobile optimized processor such as optimized for power consumption and mobile applications. The I/O interfaces 204 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 204 can also include, for example, a serial port, a parallel port, a small computer system interface (SCSI), an infrared (IR) interface, a radio frequency (RF) interface, a universal serial bus (USB) interface, and the like. The I/O interfaces 204 can include a graphical user interface (GUI) that enables a user to interact with the UE 14 Additionally, the I/O interfaces 204 may further include an imaging device, i.e. camera, video camera, etc.

The radio 206 enables wireless communication to an external access device or network. Any number of suitable wireless data communication protocols, techniques, or methodologies can be supported by the radio 206, including, without limitation: RF; LMR; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 208 can be used to store data. The data store 208 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof Moreover, the data store 208 can incorporate electronic, magnetic, optical, and/or other types of storage media.

The memory 210 can include any of volatile memory elements (e.g., random access memory (RAM, such as DRAM, SRAM, SDRAM, etc.)), nonvolatile memory elements (e.g., ROM, hard drive, etc.), and combinations thereof Moreover, the memory 210 may incorporate electronic, magnetic, optical, and/or other types of storage media. Note that the memory 210 can have a distributed architecture, where various components are situated remotely from one another, but can be accessed by the processor 202. The software in memory 202 can include one or more software programs, each of which includes an ordered listing of executable instructions for implementing logical functions. In the example of FIG. 4, the software in the memory 210 includes a suitable operating system (O/S) 214 and programs 216. The operating system 214 essentially controls the execution of other computer programs, and provides scheduling, input-output control, file and data management, memory management, and communication control and related services. The programs 216 can include various applications, add-ons, etc. configured to provide end user functionality with the UE 14. For example, exemplary programs 216 can include, but not limited to, a web browser, social networking applications, streaming media applications, games, mapping and location applications, electronic mail applications, financial applications, and the like. In context of the VSA system 10 and the wireless network 12, there will be a plurality of UEs streaming video connections for which the VSA system 10 will analyze and adjust the wireless network 12.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. A computer-implemented method of video service assurance, comprising:
obtaining measurement data and statistics from at least one network element in a network related to a plurality of video streams thereon;
performing data aggregation and analysis with the measurement data and statistics related to the plurality of video streams; and
providing actionable recommendations for improvement of the plurality of video streams to the at least one network element based on the data aggregation and analysis.

2. The computer-implemented method of claim 1, wherein the plurality of video streams comprise any of unicast, multicast or broadcast video streams.

3. The computer-implemented method of claim 1, further comprising:
obtaining the measurement data and statistics at a video service assurance system from a wireless network;
performing the data aggregation and analysis by the video service assurance system, wherein the video service assurance system utilizes analytics from one or more additional wireless networks to perform the analysis for the wireless network; and
providing the actionable recommendations from the video service assurance system to the wireless network.

4. The computer-implemented method of claim 1, wherein the data and statistics from the at least one network element comprises real-time data, substantially real-time data, historical log data, and combinations thereof.

5. The computer-implemented method of claim 1, further comprising:
obtaining the measurement data and statistics at a video service assurance system in a non- intrusive manner to the at least one network element with a software agent operating on the at least one network element for collection of historical log data.

6. The computer-implemented method of claim 1, wherein the actionable recommendations comprise one of increasing network buffer sizes and reducing a number of admitted sessions.

7. The computer-implemented method of claim 1, further comprising:
developing context based thresholds for classifying the plurality of video streams into good or poor Quality of Experience (QoE) sessions;
identifying the poor QoE sessions in the plurality of video streams; and
performing additional analysis on the poor QoE sessions.

8. The computer-implemented method of claim 7, further comprising:
utilizing objective metrics optimized for QoE in video streams to determine the poor QoE sessions.

9. The computer-implemented method of claim 1, further comprising:
performing the data aggregation and analysis on the plurality of video streams with objective metrics optimized for Quality of Experience (QoE) instead of Quality of Service (QoS) approaches.

10. The computer-implemented method of claim 9, wherein the objective metrics are predictors of subjective measures comprising Mean Opinion Score (MOS).

11. The computer-implemented method of claim 9, wherein the objective metrics comprise peak signal-to-noise ratio (PSNR), Structural SIMilarity (SSIM), and blocking and blurring metrics.

12. The computer-implemented method of claim 9, wherein the objective measures are collected using Session Description Protocol (SDP) on a session basis of the plurality of video sessions or using Open Mobile Alliance (OMA) Device Management (OMA DM) standard.

13. A video service assurance system, comprising:
at least one server communicatively coupled to a network, wherein the network comprises a plurality of user equipment (UE) participating in video streams over the network; and
each of the at least one server comprises a network interface communicatively coupled to at least one network element in the network, a processor communicatively coupled to the network interface, and memory storing instructions that, when executed, cause the processor to:
obtain measurement data and statistics from the network related to the video streams;
perform data aggregation and analysis with the measurement data and statistics related to the video streams; and
provide actionable recommendations for improvement of the video streams to the network based on the data aggregation and analysis.

14. The video service assurance system of claim 13, wherein the plurality of video streams comprise any of unicast, multicast or broadcast video streams.

15. The video service assurance system of claim 13, wherein the data and statistics from the at least one network element comprises real-time data, substantially real-time data, historical log data, and combinations thereof.

16. The video service assurance system of claim 13, wherein the actionable recommendations comprise one of increasing network buffer sizes and reducing a number of admitted sessions.

17. The video service assurance system of claim 13, wherein the that, when executed, cause the processor to:
develop context based thresholds for classifying the plurality of video streams into good or poor Quality of Experience (QoE) sessions;
utilize objective metrics optimized for QoE in video streams to determine the poor QoE sessions;
identify the poor QoE sessions in the plurality of video streams; and
perform additional analysis on the poor QoE sessions.

18. The video service assurance system of claim 13, wherein the instructions perform the data aggregation and analysis on the video streams with objective metrics optimized for Quality of Experience (QoE) instead of Quality of Service (QoS) approaches;
wherein the objective metrics are predictors of subjective measures comprising Mean Opinion Score (MOS); and
wherein the objective metrics comprise peak signal-to-noise ratio (PSNR), Structural SIMilarity (SSIM), and blocking and blurring metrics.

19. A wireless network with video service assurance, comprising:
a plurality of network elements forming a wireless network, wherein a plurality of user equipment is configured to participate in video streams over the wireless network;
at least one server communicatively coupled to at least one of the plurality of network elements; and
each of the at least one server comprises a network interface communicatively coupled to the at least one of the plurality of network elements, a processor communicatively coupled to the network interface, and memory storing instructions that, when executed, cause the processor to:
obtain measurement data and statistics from the at least one of the plurality of network elements related to the video streams;
perform data aggregation and analysis with the measurement data and statistics related to the video streams; and
provide actionable recommendations for improvement of the video streams to the at least one of the plurality of network elements based on the data aggregation and analysis.

20. The wireless network of claim 19, wherein the data aggregation and analysis is performed with objective metrics optimized for Quality of Experience (QoE) instead of Quality of Service (QoS) approaches;
wherein the objective metrics are predictors of subjective measures comprising Mean Opinion Score (MOS); and
wherein the objective metrics comprise peak signal-to-noise ratio (PSNR), Structural SIMilarity (SSIM), and blocking and blurring metrics.
